(19) United States
(12) Patent Application Publication
(10) Pub. No.: US 2019/0198206 A1
(43) Pub. Date: Jun. 27, 2019

(54) CONTROLLED VARIATION OF PARAMETERS OF MAGNETOCALORIC MATERIALS

(71) Applicant: BASF SE, Ludwigshafen am Rhein (DE)

(72) Inventors: Johan TER MAAT, Ludwigshafen (DE); Sumohan MISRA, Ludwigshafen (DE); David VAN ASTEN, Heerenveen (NL); Bernard REESINK, De Meern (NL); Wilfried HERMES, Ludwigshafen (DE); Michael ZEILINGER, Ludwigshafen (DE); Fabian SEELER, Ludwigshafen (DE); Kerstin SCHIERLE-ARNDT, Ludwigshafen (DE); Ekkehard BRUECK, Delft (NL); Van Thang NGUYEN, Utrecht (NL)

(73) Assignee: BASF SE, Ludwigshafen am Rhein (DE)

(21) Appl. No.: 16/328,912

(22) PCT Filed: Aug. 31, 2017
(86) PCT No.: PCT/EP2017/071885

§ 371 Date: Feb. 27, 2019

(30) Foreign Application Priority Data
Aug. 31, 2016 (EP) 16186705.6
Dec. 12, 2016 (EP) 16203485.4

(51) Int. Cl. H01F 1/01; C22C 30/00; F25B 21/00

(52) U.S. Cl. CPC H01F 1/015; C22C 30/00; F25B 2321/002; C22C 2202/02; F25B 21/00

(57) ABSTRACT

Described are a kit comprising at least two magnetocaloric materials having identical stoichiometry but different Curie temperature, a magnetocaloric regenerator comprising at least two magnetocaloric materials having identical stoichiometry but different Curie temperature and a process for producing at least two magnetocaloric materials having identical stoichiometry but different Curie temperature.

The present invention relates to a kit comprising a number of Z (wherein Z is at least two) magnetocaloric materials having identical stoichiometry wherein the Curie temperature of each of said Z magnetocaloric materials differs from the Curie temperature of each of the other Z-1 magnetocaloric materials by at least 0.5 K, preferably by at least 2 K; to a magnetocaloric regenerator comprising a number of Z (wherein Z is at least two) magnetocaloric materials having identical stoichiometry wherein the Curie temperature of each of said Z magnetocaloric materials differs from the Curie temperature of each of the other Z-1 magnetocaloric materials by at least 0.5 K, preferably by at least 2 K; and to a process for producing a number of Z (wherein Z is at least two) magnetocaloric materials having identical stoichiometry wherein the Curie temperature of each of said Z magnetocaloric materials differs from the Curie temperature of each of the other Z-1 magnetocaloric materials by at least 0.5 K, preferably by at least 2 K.

The term “magnetocaloric material” denotes a material exhibiting a magnetocaloric effect, i.e. a temperature change caused by exposing said material to a changing external magnetic field. Application of an external magnetic field to a magnetocaloric material in the vicinity of the Curie temperature of said magnetocaloric material causes an alignment of the randomly oriented magnetic moments of the magnetocaloric material and thus a magnetic phase transition, which can also be described as a field-induced increase of the Curie temperature of the material. This magnetic phase transition implies a loss in magnetic entropy, and under adiabatic conditions leads to an increase of the sum of the lattice and electronic entropies of the magnetocaloric material compensating for the loss of magnetic entropy (so that its total entropy remains constant). Thus, applying the external magnetic field under adiabatic conditions results in an increase of the lattice vibrations, and a heating of the magnetocaloric material occurs.

In technical applications of the magnetocaloric effect, the generated heat is removed from the magnetocaloric material by heat transfer to a heat sink in the form of a heat transfer medium, e.g. water. Subsequent removing of the external magnetic field causes a decrease of the Curie temperature back to the normal value, and thus allows the magnetic moments to revert to a random arrangement. This causes an increase of the magnetic entropy and a reduction of the sum of the lattice and electronic entropies of the magnetocaloric material compensating for the increase of magnetic entropy. Thus, removing the external magnetic field under adiabatic conditions results in a decrease of the lattice vibrations, and cooling of the magnetocaloric material occurs. The described process cycle including magnetization and demagnetization is typically performed periodically in technical applications.

A regenerator (also referred to as regenerative heat exchanger) is a type of heat exchanger comprising at least one heat-storing material and fixtures to bring the heat-storing material in alternating manner in contact with a hot heat transfer fluid capable of transferring heat to the heat storing material and a cold heat transfer fluid capable of absorbing heat from the heat storing material. When the hot heat transfer fluid is brought into contact with the heat-storing material, heat from the hot heat transfer fluid is transferred to and intermittently stored in the heat-storing material. Then the heat transfer fluid which has transferred its heat to the heat exchanging material is displaced with the cold heat transfer fluid, which absorbs heat from the heat storing material.

In a magnetocaloric regenerator, the function of the heat storing material(s) is fulfilled by material(s) exhibiting a magnetocaloric effect (magnetocaloric materials). A magnetocaloric regenerator comprises means for repeatedly applying a magnetic field to said magnetocaloric material(s) and removing said magnetic field. In technical applications, a magnetocaloric regenerator is usually placed between a hot side heat exchanger and a cold side heat exchanger. A temperature gradient across the magnetocaloric regenerator is established between the cold side heat exchanger and the hot side heat exchanger, and heat is “pumped” from the cold-side heat-exchanger to the hot-side heat exchanger.

A magnetic regenerator cycle consists of four stages, starting from a state where no magnetic field is applied. First, applying a magnetic field causes heating of the magnetic regenerator by the magnetocaloric effect, thereby causing the cold heat transfer fluid within the magnetocaloric regenerator to heat up. Second, heat transfer fluid flows through the magnetocaloric regenerator in the direction from the cold-side heat exchanger to the hot-side heat exchanger. Heat is then released from the heat transfer fluid to the hot-side heat exchanger. Third, removing the magnetic field causes cooling of the magnetic regenerator by the magnetocaloric effect thereby causing the hot heat transfer fluid within the magnetocaloric regenerator to cool down. Last, the heat transfer fluid flows through the magnetocaloric regenerator in the direction from the hot-side heat exchanger to the cold-side heat exchanger. The cooled heat transfer fluid takes up heat from the cold-side heat exchanger, and the cold-side heat exchanger can be used to provide cooling to another body or system.

It is known that the magnetocaloric effect of a material varies with temperature and has its maximum in the vicinity of the Curie temperature of said material. Thus, in order to optimize the performance of the magnetocaloric regenerator it is desirable that at each position of the flow path of the heat transfer fluid across the magnetocaloric regenerator the Curie temperature coincides with the temperature determined for said position by the above-described temperature gradient. In order to approach these preferable condition, a magnetocaloric regenerator preferably comprises a cascade comprising three or more different magnetocaloric materials, preferably 5 to 100 different magnetocaloric materials having different Curie temperatures, wherein in said cascade said magnetocaloric materials are arranged in succession by ascending or descending Curie temperature, i.e. the magnetocaloric material having the highest Curie temperature is arranged at one end of the cascade, the magnetocaloric material having the second highest Curie temperature follows and so on, and the magnetocaloric material having the lowest Curie temperature is placed at the opposite end of the cascade. The end of the cascade where the magnetocaloric material having the highest Curie temperature is located corresponds to the hot side of the magnetocaloric cascade, and the end of the cascade where the magnetocaloric material having the lowest Curie temperature is located corresponds to the cold side of the magnetocaloric cascade.

In such a magnetocaloric cascade, cooling resp. heating of each magnetocaloric material (with the exception of the first one) to a temperature near its Curie temperature is effected by the preceding magnetocaloric material, and each magnetocaloric material (with the exception of the last one) effects cooling resp. heating of the succeeding magnetocaloric material to a temperature near its Curie temperature. In other words, the first magnetocaloric material effects cooling down resp. heating up the second magnetocaloric material to a temperature near the Curie temperature of the second magnetocaloric material, and so on with any further magnetocaloric material contained in the cascade.

This way, the cooling effect achieved can be greatly increased in comparison with a magnetocaloric regenerator comprising a single magnetocaloric material.

Cascades comprising three or more different magnetocaloric materials, preferably 5 to 100 different magnetocaloric materials which exhibit a magnetocaloric effect at different temperatures, wherein in said cascade said magnetocaloric materials are arranged in succession by ascending or descending Curie temperature are described in e.g. in US 2014/0202171 A1 and U.S. Pat. No. 8,763,407 B2. Herein, variation of the Curie temperature is achieved by varying the stoichiometry of the magnetocaloric materials in the cascade. Preferably, in such cascade the difference in the Curie temperatures between two succeeding magnetocaloric materials is 0.5 to 6 K.

However, in order to achieve the desired variation of the Curie temperature in steps of 6 K or less, very small variations of the stoichiometry are needed, because the Curie temperature is very sensitive to changes of the stoichiometry. Unfortunately, it is extremely difficult to hit the desired stoichiometry for each particular Curie temperature with the required accuracy; and preparation of the large number of magnetocaloric materials with varying stoichiometry is elaborate because a correspondingly large number of different precursor mixtures needs to be prepared and processed.

H. Yu et al (Journal of Alloys and Compounds 649 (2015) 1043-1047) investigated the effect of heat treatment on the structure and magnetocaloric properties like the Curie temperature of Mn_{1.15}Fe_{0.85}P_{0.52}Si_{0.45}B_{0.03}. Combination of materials of the composition Mn_{1.15}Fe_{0.85}P_{0.52}Si_{0.45}B_{0.03} having different Curie temperature within one magnetocaloric device is not considered in this paper.

Related prior art is also CN 104 357 727 A.

Surprisingly it has been found that for magnetocaloric materials having a stoichiometry as defined by formula (I) given below, the Curie temperature may be adjusted very precisely by varying the temperature of a heat treatment to which said magnetocaloric material is subjected during its preparation. This finding enables the preparation of a plurality of magnetocaloric materials having different Curie temperatures at identical stoichiometry so that the above-mentioned difficulties are omitted.

According to one aspect of the present invention there is provided a kit comprising Z magnetocaloric materials of a composition according to formula (I)

(MnₓFe₁₋ₓ)₂₊ᵤP_{y}SiᵥC_{z}NᵣB_{w} (I)

wherein

0.3≤x≤0.7 preferably 0.35≤x≤0.65

−0.12≤u≤0.10, preferably −0.05≤u≤0.05

0.3≤y≤0.75, preferably 0.4≤y≤0.7

0.25≤v≤0.7, preferably 0.3≤v≤0.6

0≤z≤0.15, preferably 0.003≤z≤0.12

0≤r≤0.1, preferably 0.005≤r≤0.07

0≤w≤0.1, preferably 0.01≤w≤0.08

(y+v+w)≤1.05, preferably ≤1.02, preferably ≤1

(y+v+w+r)≥0.95, preferably ≥0.98, preferably ≥1

wherein Z≥2

wherein u, x, y, v, z, r and w are identical for each of said Z magnetocaloric materials according to formula (I)

wherein the Curie temperature of each of said Z magnetocaloric materials according to formula (I) differs from the Curie temperature of each of the other Z-1 magnetocaloric materials according to formula (I) by at least 0.5 K, preferably by at least 2 K.

A magnetocaloric material of a composition according to formula (I) is herein also referred to as a magnetocaloric material according to formula (I).

Thus, a kit according to the invention comprises a number (Z) of at least two magnetocaloric materials having identical stoichiometry as defined by formula (I), wherein the Curie temperature of each of said Z magnetocaloric materials according to formula (I) differs from the Curie temperature of each other of said Z magnetocaloric materials according to formula (I) by at least 0.5 K, preferably by at least 2 K. As used herein, identical stoichiometry as defined by formula (I) means that for each of said Z magnetocaloric materials of said kit, the variables x, u, y, v, r, z and w have the same value (i.e. x is the same for all of the first to Zth material, u is the same for all of the first to Zth material, y is the same for all of the first to Zth material, v is the same for all of the first to Zth material, r is the same for all of the first to Zth material, z is the same for all of the first to Zth material and w is the same for all of the first to Zth material). In other words, the Z magnetocaloric materials of a kit according to the present invention are defined by one and the same empirical formula falling in the scope of above-defined formula (I).

In a kit according to the present invention, each of said Z magnetocaloric materials according to formula (I) is provided in such manner that it is separated from each of the other Z-1 magnetocaloric materials according to formula (I) and is prevented from intermixing with any of the other Z-1 magnetocaloric materials according to formula (I). This may be achieved by providing each of said Z magnetocaloric materials according to formula (I) in a separate package or vessel or in the form of a separate piece or shaped body (e.g. in the form of a plate, a sheet or a block) or by any other suitable means.

Methods for determining the stoichiometry of a magnetocaloric material according to formula (I) are known in the art and include X-ray fluorescence analysis (XRF), neutron diffraction, wave-length dispersive X-ray analysis (WDX) and wet chemical methods like inductively coupled plasma (ICP). Preferably the method for determining the stoichiometry of the magnetocaloric material according to formula (I) is ICP.

Generally, the ratio of the elements in a magnetocaloric material according to formula (I) substantially resembles the ratio of said elements in the mixture of precursors used to prepare said magnetocaloric material (for further details, see below). Thus, the ratio of the elements in a magnetocaloric material according to formula (I) may be controlled by and derived from the ratio of said elements in the mixture of precursors used to prepare said magnetocaloric material.

The Curie temperature Tc is determined from differential scanning calorimetry (DSC) zero field measurements as the temperature in the region of the magnetic phase transition at which the specific heat capacity is at its maximum value, or from records of the magnetization as function of temperature under an applied magnetic field as the temperature where dM/dT is at its maximum value.

Preferably, in a kit according to the present invention, Z (the number of magnetocaloric materials having identical stoichiometry but different Curie temperature) is in the range of from 3 to 100, preferably of from 5 to 100.

Preferably, said Z magnetocaloric materials according to formula (I) have Curie temperatures in the range of from 220 K to 330 K, preferably 250 K to 320 K, further preferably 290 K to 320 K.

Magnetocaloric materials of a composition according to formula (I) as defined above and processes for preparing said magnetocaloric materials are known as such.

Magnetocaloric materials which contain manganese, iron, silicon and phosphorus are disclosed in WO 2011/083446A1 and US 2011/0220838 A1. The examples of these patent applications show that slight variations of the stoichiometry result in significant changes of the Curie temperature.

Magnetocaloric materials which contain manganese, iron, silicon, phosphorus, and boron are disclosed in WO 2015/018610, WO 201/018705 and WO 2015/01867. The examples of these applications show that slight variation of the boron content results in significant changes of the Curie temperature.

Magnetocaloric materials which contain manganese, iron, silicon, phosphorus, nitrogen and optionally boron are disclosed in non-prepublished EP patent application of application number 15192313.3-1556 published as WO 2017/072334 A1. The examples of this patent application show that slight variation of the nitrogen content results in significant changes of the Curie temperature.

Magnetocaloric materials which contain manganese, iron, silicon, phosphorus, carbon, and optionally one or both of boron and nitrogen are disclosed in non-prepublished EP patent application of application Ser. No. 16/173,919.8-1556. The examples of this patent application show that slight variation of the carbon content results in significant changes of the Curie temperature.

Thus, none of these documents, although disclosing magnetocaloric materials according to above-defined formula (I), discloses or suggests that the Curie temperature may be adjusted or controlled by any other means than by the stoichiometry. However, this approach has the above-described disadvantages, because as shown by the examples of the above-referenced patent applications, slight variations of the stoichiometry may cause significant changes of the Curie temperature.

Without wishing to be bound by theory, it is assumed that by varying the temperature of a heat treatment to which a magnetocaloric material of a composition according to formula (I) is subjected during its preparation has an effect on the distribution of different phases which may be present in each of said Z magnetocaloric materials, and said distribution of phases in turn has an influence on the Curie temperature, and typically also on other parameters relevant for the technical application of magnetocaloric materials, like the thermal hysteresis and the entropy change.

In a magnetocaloric material having a composition according to formula (I), one, two or all of the following phases may be present:
(i) a phase having a hexagonal structure of the composition M₂X with a crystal lattice having the space group P-62m
(ii) a phase having a cubic structure of the composition M₃X with a crystal lattice having the space group Fm-3m
(iii) a phase having a hexagonal structure of the composition M₅X₃ with a crystal lattice having the space group P6₃/mcm.

wherein in each case M denotes atoms of elements selected from the group consisting of Fe and Mn, and X denotes atoms of elements selected from the group consisting of P, Si, C, N and B.

Phases (ii) and (iii) are also referred to as secondary phases. The presence of phases (i), (ii) and (iii) can be verified by means of X-ray diffraction or Electron Beam Secondary Diffraction (EBSD). EBSD allows a direct allocation of crystal structure to the grains seen in Scanning Electron Microscope photographs.

It is understood that the stoichiometry of a magnetocaloric material defined by formula (I), which is an empirical formula (gross formula), is averaged over all phases (i), (ii) and (iii) which are present in said magnetocaloric material.

Usually, in preparation of magnetocaloric materials, the focus is on maximizing the content of phase (i), in order to maximize the magnetocaloric effect. However, surprisingly it has been found that allowing for a certain amount of one or both of the above-defined secondary phases (ii) and (iii) does not compromise the desired magnetocaloric effect in spite of the corresponding reduction of the content of phase (i), because the magnetocaloric properties do not necessarily all have their maximum at a phase distribution where the content of phase (i) is at its maximum. Thus, adjusting the contents of the main phase (i) and the secondary phases (ii) and (iii) provides a means for adjusting the Curie temperature and other parameters relevant for the technical application of magnetocaloric materials, like the thermal hysteresis and the entropy change.

In a preferred kit according to the present invention,

each of said Z magnetocaloric materials according to formula (I) comprises
(i) a phase having a hexagonal structure of the composition M₂X with a crystal lattice having the space group P-62m in a weight fraction of from 80% to 100%
(ii) a phase having a cubic structure of the composition M₃X with a crystal lattice having the space group Fm-3m in a weight fraction of from 0% to 20% and
(iii) a phase having a hexagonal structure of the composition M₅X₃ with a crystal lattice having the space group P6₃/mcm in a weight fraction of from 0% to 20%

wherein in each case M denotes atoms of elements selected from the group consisting of Fe and Mn, and X denotes atoms of elements selected from the group consisting of P, Si, C, N and B

wherein for each of said Z magnetocaloric materials the sum of the weight fractions of phases (i), (ii) and (iii) is 100%

wherein each of said Z magnetocaloric materials according to formula (I) differs from each of the other Z-1 magnetocaloric materials according to formula (I) by the weight fractions of at least two of the phases (i), (ii) and (iii).

Thus, the kit according to the invention comprises a number (Z) of at least two magnetocaloric materials having identical stoichiometry as defined by formula (I), wherein each of said Z magnetocaloric materials according to formula (I) differs from each other of said Z magnetocaloric materials according to formula (I) by the weight fractions of at least two of the above-defined phases (i), (ii) and (iii).

The weight fractions of phases (i), (ii) and (iii) can be determined by Rietveld refinement of X-ray diffraction data.

In a preferred kit according to the present invention, at least one of said Z magnetocaloric materials according to formula (I) comprises
(i) a phase having a hexagonal structure of the composition M₂X with a crystal lattice having the space group P-62m in a weight fraction of from 80% to <100%, and
(ii) a phase having a cubic structure of the composition M₃X with a crystal lattice having the space group Fm-3m in a weight fraction of from >0% to 20%

wherein in each case M denotes atoms of elements selected from the group consisting of Fe and Mn, and X denotes atoms of elements selected from the group consisting of P, Si, C, N and B

wherein in said magnetocaloric material according to formula (I) the sum of the weight fractions of phases (i) and (ii) is 100%.

Alternatively, in a preferred kit according to the present invention, at least one of said Z magnetocaloric materials according to formula (I) comprises
(i) a phase having a hexagonal structure of the composition M₂X with a crystal lattice having the space group P-62m in a weight fraction of from 80% to <100%, and
(iii) a phase having a hexagonal structure of the composition M₅X₃ with a crystal lattice having the space group P6₃/mcm in a weight fraction of from >0% to 20%

wherein in in each case M denotes atoms of elements selected from the group consisting of Fe and Mn, and X denotes atoms of elements selected from the group consisting of P, Si, C, N and B

wherein in said magnetocaloric material according to formula (I) the sum of the weight fractions of phases (i) and (iii) is 100%.

Alternatively, in a preferred kit according to the present invention, at least one of said Z magnetocaloric materials according to formula (I) comprises
(i) a phase having a hexagonal structure of the composition M₂X with a crystal lattice having the space group P-62m in a weight fraction of from 80% to <100%
(ii) a phase having a cubic structure of the composition M₃X with a crystal lattice having the space group Fm-3m in a weight fraction of from >0% to 20%

and
(iii) a phase having a hexagonal structure of the composition M₅X₃ with a crystal lattice having the space group P6₃/mcm in a weight fraction of from >0% to 20%

wherein in each case M denotes atoms of elements selected from the group consisting of Fe and Mn, and X denotes atoms of elements selected from the group consisting of P, Si, C, N and B

wherein in said magnetocaloric material according to formula (I) the sum of the weight fractions of phases (i), (ii) and (iii) is 100%.

Furthermore, a kit according to the invention of any type as described above may comprise one magnetocaloric material according to formula (I) comprising
(i) a phase having a hexagonal structure of the composition M₂X with a crystal lattice having the space group P-62m in a weight fraction of 100%

wherein in each case M denotes atoms of elements selected from the group consisting of Fe and Mn, and X denotes atoms of elements selected from the group consisting of P, Si, C, N and B.

As used herein, a magnetocaloric material according to formula (I) comprising
(i) a phase having a hexagonal structure of the composition M₂X with a crystal lattice having the space group P-62m in a weight fraction of 100%

is a magnetocaloric material according to formula (I) which does not comprise any of the above-defined secondary phases (ii) and (iii).

Thus, in certain cases a kit according to the invention as described herein comprises one magnetocaloric material according to formula (I) comprising
(i) a phase having a hexagonal structure of the composition M₂X with a crystal lattice having the space group P-62m in a weight fraction of 100%

wherein in each case M denotes atoms of elements selected from the group consisting of Fe and Mn, and X denotes atoms of elements selected from the group consisting of P, Si, C, N and B.

More specifically, such kind of preferred kit according to the invention comprises Z magnetocaloric materials according to formula (I), wherein

one of said Z magnetocaloric materials according to formula (I) comprises
(i) a phase having a hexagonal structure of the composition M₂X with a crystal lattice having the space group P-62m in a weight fraction of 100%

and each of the other Z-1 magnetocaloric materials according to formula (I) comprises
(i) a phase having a hexagonal structure of the composition M₂X with a crystal lattice having the space group P-62m in a weight fraction of from 80% to <100%
(ii) a phase having a cubic structure of the composition M₃X with a crystal lattice having the space group Fm-3m in a weight fraction of ≤20%

and
(iii) a phase having a hexagonal structure of the composition M₅X₃ with a crystal lattice having the space group P6₃/mcm in a weight fraction of ≤20%.

wherein in each of said Z-1 magnetocaloric materials according to formula (I) the weight fraction of at least one of said phases (ii) and (iii) is >0

wherein in each case M denotes atoms of elements selected from the group consisting of Fe and Mn, and X denotes atoms of elements selected from the group consisting of P, Si, C, N and B

wherein for each of said Z magnetocaloric materials according to formula (I) the sum of the weight fractions of phases (i), (ii) and (iii) is 100%

wherein each of said Z magnetocaloric materials according to formula (I) differs from each of the other Z-1 magnetocaloric materials according to formula (I) by the weight fractions of at least two of the phases (i), (ii) and (iii).

In other cases, a kit according to the invention as described herein does not comprise a magnetocaloric material according to formula (I) comprising
(i) a phase having a hexagonal structure of the composition M₂X with a crystal lattice having the space group P-62m in a weight fraction of 100%

wherein in each case M denotes atoms of elements selected from the group consisting of Fe and Mn, and X denotes atoms of elements selected from the group consisting of P, Si, C, N and B.

More specifically, such kind of preferred kit according to the invention comprises Z magnetocaloric materials according to formula (I), wherein each of said Z magnetocaloric materials according to formula (I) comprises
(i) a phase having a hexagonal structure of the composition M₂X with a crystal lattice having the space group P-62m in a weight fraction of a of from 80% to <100%
(ii) a phase having a cubic structure of the composition M₃X with a crystal lattice having the space group Fm-3m in a weight fraction of ≤20%

and
(iii) a phase having a hexagonal structure of the composition M₅X₃ with a crystal lattice having the space group P6₃/mcm in a weight fraction of <20%

wherein in each of said Z magnetocaloric materials according to formula (I) the weight fraction of at least one of said phases (ii) and (iii) is >0

wherein in each case M denotes atoms of elements selected from the group consisting of Fe and Mn, and X denotes atoms of elements selected from the group consisting of P, Si, C, N and B

wherein for each of said Z magnetocaloric materials according to formula (I) the sum of the weight fractions of phases (i), (ii) and (iii) is 100%

wherein each of said Z magnetocaloric materials according to formula (I) differs from each of the other Z-1 magnetocaloric materials by the weight fractions of at least two of the phases (i), (ii) and (iii).

Surprisingly, it has been found that both secondary phases (ii) and (iii) do not exhibit significant amounts of P on the positions occupied by non-metallic elements X, in contrast to phase (i). This allows for a wide variation of the ratio between P and Si. In turn, the content of Si is enriched in said secondary phases, compared to the average stoichiometry defined by formula (I). Thus, the total amount of secondary phase determines how much Si remains on the non-metal positions in phase (i), which in turn determines primarily the important magnetocaloric property Tc.

Further preferably, in a kit according to any type as described above, at least one of said Z magnetocaloric materials according to formula (I) exhibits

a ratio between
the atomic fraction of phosphorus in said phase (i)
and the atomic fraction of phosphorus in said phase (ii)

of 3 or more, preferably 4 or more, further preferably 5 or more and/or

a ratio between
the atomic fraction of phosphorus in said phase (i)
and the atomic fraction of phosphorus in said phase (iii)

of 3 or more, preferably 4 or more, further preferably 5 or more

wherein the atomic fraction of phosphorus in each case is based on the sum of the number of atoms of Fe, Mn, P, Si, C, N and B in said phase.

Further preferably, in at least one of said Z magnetocaloric materials according to formula (I)

in said phase (ii) the atomic fraction of phosphorus is 5 at.-% or less, preferably 4 at.-%, preferably 3 at.-% or less based on the sum of the number of atoms of Fe, Mn, P, Si, C, N and B in said phase (ii)

and/or

in said phase (iii) the atomic fraction of phosphorus is 5 at.-% or less, preferably 4 at.-%, preferably 3 at.-% or less based on the sum of the number of atoms of Fe, Mn, P, Si, C, N and B in said phase (iii).

The atomic fractions of phosphorus in phases (i), (ii) and (iii) can be determined by means of energy dispersive X-ray spectroscopy (EDX), Secondary Ion Mass Spectroscopy (SIMS), Extended X-Ray Absorption Fine Structure (EXAFS), X-Ray Absorption Near Edge Structure (XANES) or Laser Induced Plasma Spectroscopy (LIPS). As long as the grain size of the phases within the magnetocaloric material is not below 1 μm EDX is the most convenient and sufficiently sensitive method; very fine grained magnetocaloric materials can be analysed by SIMS.

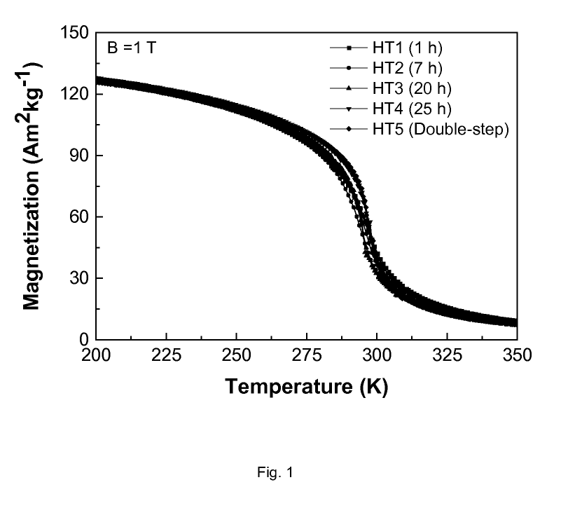

The above-mentioned phases (i), (ii) and (iii) have been described for the system FeMnP₁₋ₓSiₓ (0≤x≤1) by Höglin et al., RSC Adv., 2015, 5, 8278-8284. Herein, the phase diagram according to FIG. 1 shows at x=0.50 a transition from a single phase referred to as “Fe₂P-type” to a three phase region with coexisting phases referred to as “Fe₂P-type”, “Fe₃Si-type” and “Mn₅Si₃-type”.

Höglin's publication does not disclose that the Curie temperature can be varied by varying the distribution of the above-mentioned phases in a magnetocaloric material of the composition FeMnP₁₋ₓSiₓ (0≤x≤1) without varying the stoichiometry. Indeed as regards variation of the Curie temperature, only the well-known approach of varying the stoichiometry is disclosed by Höglin. It is also noted that Höglin et al., RSC Adv., 2015, 5, 8278-8284 does not provide data on the distribution of P and Si between the phase referred to as “Fe₂P-type” and the phases referred to as “Fe₃Si-type” and “Mn₅Si₃-type”. Indeed, since it is well known that the Fe₂P-type structure tolerates a wide variation of the P/Si ratio (in this regard, consider the broad range of x studied by Höglin et al.), the same could be expected for the secondary phases.

Magnetocaloric materials which contain manganese, iron, silicon and phosphorus, and methods for their preparation are disclosed in WO 2011/083446A1 and US 2011/0220838 A1. Preferred magnetocaloric materials of a composition according to formula (I), which contain manganese, iron, silicon and phosphorus, have a composition according to formula (Ia)

(MnₓFe₁₋ₓ)₂₊ᵤP_{y}Siᵥ (Ia)

wherein

−0.12≤u≤0.10, preferably −0.05≤u≤0.05

0.3≤x≤0.7 preferably 0.35≤x≤0.65

0.3≤y≤0.75, preferably 0.4≤y≤0.7

0.25≤v≤0.7, preferably 0.3≤v≤0.6

0.95≤(y+v)≤1.05, preferably 0.98≤(y+v)≤1.02

Magnetocaloric materials which contain manganese, iron, silicon, phosphorus, and boron, and methods for their preparation are disclosed in WO 2015/018610, WO 201/018705 and WO 2015/01867. Preferred magnetocaloric materials of a composition according to formula (I), which contain manganese, iron, silicon, phosphorus and boron, have a composition according to formula (Ib)

(MnₓFe₁₋ₓ)₂₊ᵤP_{y}SiᵥB_{w} (Ib)

wherein

−0.12≤u≤0.10, preferably −0.05≤u≤0.05

0.3≤x≤0.7 preferably 0.35≤x≤0.65

0.3≤y≤0.75, preferably 0.4≤y≤0.7

0.25≤v≤0.7, preferably 0.3≤v≤0.6

0.005≤w≤0.1, preferably 0.01≤w≤0.08

0.955≤(y+v+w)≤1.05, preferably 0.98≤(y+v+w)≤1.02.

Magnetocaloric materials which contain manganese, iron, silicon, phosphorus, nitrogen and optionally boron and methods for their preparation are disclosed in non-prepublished EP patent application of application Ser. No. 15/192,313.3-1556 published as WO 2017/072334 A1.

Preferred magnetocaloric materials which contain manganese, iron, silicon, phosphorus, nitrogen and optionally boron, have a composition according to formula (Ic)

(MnₓFe₁₋ₓ)₂₊ᵤP_{y}SiᵥNᵣB_{w} (Ic)

wherein

−0.12≤u≤0.10, preferably −0.05≤u≤0.05

0.3≤x≤0.7 preferably 0.35≤x≤0.65,

0.3≤y≤0.75, preferably 0.4≤y≤0.7

0.25≤v≤0.7, preferably 0.3≤v≤0.6,

0.001≤r≤0.1, preferably 0.005≤r≤0.07,

0≤w≤0.1, preferably 0.01≤w≤0.08

(y+v+w)≤1.05, preferably ≤1.02, preferably ≤1

(y+v+w+r)≥0.95, preferably ≥0.98, preferably ≥1.

Preferred magnetocaloric materials of a composition according to formula (I), which contain manganese, iron, silicon, phosphorus and nitrogen have a composition according to formula (Id)

(MnₓFe₁₋ₓ)₂₊ᵤP_{y}SiᵥNᵣ (Id)

wherein

−0.12≤u≤0.10, preferably −0.05≤u≤0.05

0.3≤x≤0.7 preferably 0.35≤x≤0.65,

0.3≤y≤0.75, preferably 0.4≤y≤0.7

0.25≤v≤0.7, preferably 0.3≤v≤0.6

0.001≤r≤0.1, preferably 0.005≤r≤0.07

(y+v)≤1.05, preferably ≤1.02, preferably ≤1

(y+v+r)≥0.95, preferably ≥0.98, preferably ≥1.

Preferred magnetocaloric materials of a composition according to formula (I), which contain manganese, iron, silicon, phosphorus, nitrogen and boron have a composition according to formula (Ie)

(MnₓFe₁₋ₓ)₂₊ᵤP_{y}SiᵥNᵣB_{w} (Ie)

wherein

−0.12≤u≤0.10, preferably −0.05≤u≤0.05

0.3≤x≤0.7 preferably 0.35≤x≤0.65,

0.3≤y≤0.75, preferably 0.4≤y≤0.7

0.25≤v≤0.7, preferably 0.3≤v≤0.6

0.001≤r≤0.1, preferably 0.005≤r≤0.07

0.005≤w≤0.1, preferably 0.01≤w≤0.08

(y+v+w)≤1.05, preferably ≤1.02, preferably ≤1

(y+v+w+r)≥0.95, preferably ≥0.98, preferably ≥1.

Magnetocaloric materials which contain manganese, iron, silicon, phosphorus, carbon, and optionally one or both of boron and nitrogen, and methods for their preparation are disclosed in non-prepublished EP patent application of application Ser. No. 16/173,919.8 1556.

Preferred magnetocaloric materials of a composition according to formula (I), which contain manganese, iron, silicon, phosphorus and carbon, have a composition according to formula (If)

(MnₓFe₁₋ₓ)₂₊ᵤP_{y}SiᵥC_{z} (If)

wherein

−0.12≤u≤0.10, preferably −0.05≤u≤0.05

0.3≤x≤0.7 preferably 0.35≤x≤0.65

0.3≤y≤0.75, preferably 0.4≤y≤0.7

0.25≤v≤0.7, preferably 0.3≤v≤0.6

0.001≤z≤0.15, preferably 0.003≤z≤0.12

0.95≤(y+v)≤1.05, preferably 0.98≤(y+v)≤1.02.

Preferred magnetocaloric materials of a composition according to formula (I), which contain manganese, iron, silicon, phosphorus, carbon and boron, have a composition according to formula (Ig)

(MnₓFe₁₋ₓ)₂₊ᵤP_{y}SiᵥC_{z}B_{w} (Ig)

wherein

−0.12≤u≤0.10, preferably −0.05≤u≤0.05

0.3≤x≤0.7 preferably 0.35≤x≤0.65

0.3≤y≤0.75, preferably 0.4≤y≤0.7

0.25≤v≤0.7, preferably 0.3≤v≤0.6

0.001≤z≤0.15, preferably 0.003≤z≤0.12

0.005≤w≤0.1, preferably 0.01≤w≤0.08

0.95≤(y+v+w)≤1.05, preferably 0.98≤(y+v+w)≤1.02.

Preferred magnetocaloric materials of a composition according to formula (I), which contain manganese, iron, silicon, phosphorus, carbon and nitrogen, have a composition according to formula (Ih)

(MnₓFe₁₋ₓ)₂₊ᵤP_{y}SiᵥC_{z}Nᵣ (Ih)

wherein

−0.12≤u≤0.10, preferably −0.05≤u≤0.05

0.3≤≤x≤0.7 preferably 0.35≤x≤0.65

0.3≤y≤0.75, preferably 0.4≤y≤0.7

0.25≤v≤0.7, preferably 0.3≤v≤0.6

0.001≤z≤0.15, preferably 0.003≤z≤0.12

0.001≤r≤0.1, preferably 0.005≤r≤0.07

(y+v)≤1.05, preferably ≤1.02, preferably ≤1

(y+v+r)≥0.95, preferably ≥0.98, preferably ≥1.

Preferred magnetocaloric materials of a composition according to formula (I), which contain manganese, iron, silicon, phosphorus, carbon, boron and nitrogen, have a composition according to formula (Ii)

(MnₓFe₁₋ₓ)₂₊ᵤP_{y}SiᵥC_{z}NᵣB_{w} (Ii)

wherein

−0.12≤u≤0.10, preferably −0.05≤u≤0.05

0.3≤x≤0.7 preferably 0.35≤x≤0.65

0.3≤y≤0.75, preferably 0.4≤y≤0.7

0.25≤v≤0.7, preferably 0.3≤v≤0.6

0.001≤z≤0.15, preferably 0.003≤z≤0.12

0.001≤r≤0.1, preferably 0.005≤r≤0.07

0.005≤w≤0.1, preferably 0.01≤w≤0.08

(y+v+w)≤1.05, preferably ≤1.02, preferably ≤1

(y+v+w+r)≥0.95, preferably ≥0.98, preferably ≥1.

Preferred kits according to the present invention are those which exhibit two or more of the above-defined preferred features in combination.

According to a second aspect of the present invention there is provided a magnetocaloric regenerator comprising Z magnetocaloric materials of a composition according to formula (I)

(MnₓFe₁₋ₓ)₂₊ᵤP_{y}SiᵥC_{z}NᵣB_{w} (I)

wherein

0.3≤x≤0.7 preferably 0.35≤x≤0.65,

−0.12≤u≤0.10, preferably −0.05≤u≤0.05

0.3≤y≤0.75, preferably 0.4≤y≤0.7

0.25≤v≤0.7, preferably 0.3≤v≤0.6

0≤z≤0.15, preferably 0.003≤z≤0.12,

0≤r≤0.1, preferably 0≤r≤0.07,

0≤w≤0.1, preferably 0≤w≤0.08

(y+v+w)≤1.05, preferably ≤1.02, preferably ≤1

(y+v+w+r)≥0.95, preferably ≥0.98, preferably ≥1

wherein Z≥2

wherein u, x, y, v, z, r and w are identical for each of said Z magnetocaloric materials according to formula (I)

wherein the Curie temperature of each of said Z magnetocaloric materials according to formula (I) differs from the Curie temperature of each of the other Z-1 magnetocaloric materials according to formula (I) by at least 0.5 K, preferably by at least 2 K.

Thus, the magnetocaloric regenerator according to the invention comprises a number (Z) of at least two magnetocaloric materials having identical stoichiometry as defined by formula (I), wherein the Curie temperature of each of said Z magnetocaloric materials according to formula (I) differs from the Curie temperature of each other of said Z magnetocaloric materials according to formula (I) by at least 0.5 K, preferably by at least 2 K. As used herein, identical stoichiometry as defined by formula (I) means that for each of said Z magnetocaloric materials of said magnetocaloric regenerator, the variables x, u, y, v, r, z and w have the same value. In other words, the Z magnetocaloric materials of a magnetocaloric regenerator according to the present invention are defined by one and the same empirical formula falling in the scope of above-defined formula (I).

Preferably a magnetocaloric regenerator according to the invention comprises a cascade comprising Z magnetocaloric materials of a composition according to formula (I)

(MnₓFe₁₋ₓ)₂₊ᵤP_{y}SiᵥC_{z}NᵣB_{w} (I)

wherein

0.3≤x≤0.7 preferably 0.35≤x≤0.65,

−0.12≤u≤0.10, preferably −0.05≤u≤0.05

0.3≤y≤0.75, preferably 0.4≤y≤0.7

0.25≤v≤0.7, preferably 0.3≤v≤0.6

0≤z≤0.15, preferably 0.003≤z≤0.12,

0≤r≤0.1, preferably 0≤r≤0.07,

0≤w≤0.1, preferably 0≤w≤0.08

(y+v+w)≤1.05, preferably ≤1.02, preferably ≤1

(y+v+w+r)≥0.95, preferably ≥0.98, preferably ≥1

wherein Z≥3

wherein u, x, y, v, z, r and w are identical for each of said Z magnetocaloric materials of a composition according to formula (I)

wherein the Curie temperature of each of said Z magnetocaloric materials according to formula (I) differs from the Curie temperature of each of the other Z-1 magnetocaloric materials according to formula (I) by at least 0.5 K, preferably by at least 2 K

wherein in said cascade said magnetocaloric materials according to formula (I) are arranged in succession by ascending or descending Curie temperature.

Thus, the magnetocaloric regenerator according to the invention comprises a cascade comprising a number (Z) of at least two magnetocaloric materials having identical stoichiometry as defined by formula (I), wherein the Curie temperature of each of said Z magnetocaloric materials according to formula (I) differs from the Curie temperature of each other of said Z magnetocaloric materials according to formula (I) by at least 0.5 K, preferably by at least 2 K. As used herein, identical stoichiometry as defined by formula (I) means that for each of said Z magnetocaloric materials of said cascade, the variables x, u, y, v, z, r, and w have the same value. In other words, the Z magnetocaloric materials of a cascade of a magnetocaloric regenerator according to the present invention are defined by one and the same empirical formula falling in the scope of above-defined formula (I).

The number of different magnetocaloric materials in the cascade and their Curie temperatures are selected depending on the temperature span to be covered in the desired application. Preferably, the difference in the Curie temperatures between the magnetocaloric material with the highest Curie temperature and the magnetocaloric material with the lowest Curie temperature corresponds to said temperature span.

Preferably, in a magnetocaloric regenerator according to the present invention, in said cascade Z (the number of magnetocaloric materials having identical stoichiometry but different Curie temperature) is in the range of from 3 to 100, preferably of from 5 to 100.

Preferably, said Z magnetocaloric materials according to formula (I) have Curie temperatures in the range of from 220 K to 330 K, preferably 250 K to 320 K, further preferably 290 K to 320 K.

Preferably, in said cascade the temperature difference between two succeeding magnetocaloric materials according to formula (I) is in each case in the range of from 0.5 K to 6 K, preferably 0.5 K to 4 K and even more preferably 0.5 K to 2.5 K.

Within said cascade, the plurality of succeeding magnetocaloric materials may be present in any suitable shape, e.g. in the form of a plurality of plates, sheets, layers, shaped bodies (preferably shaped bodies exhibiting a plurality of passages, e.g. channels, extending through said shaped body allowing for the flow of heat transfer fluids), porous shaped bodies (e.g. open-cell foams or porous bodies obtained by sintering together a plurality of particles of a magnetocaloric material having a composition according to formula (I) or gluing together a plurality of particles of a magnetocaloric material having a composition according to formula (I) by means of a binding agent) or packed beds each comprising a plurality of individual particles of a magnetocaloric material having a composition according to formula (I), wherein in said beds the particles are not connected to each other. For producing the shaped bodies as well as the packed beds described herein, in certain cases it is preferred that the particles of magnetocaloric materials having a composition according to formula (I) have spherical shape or a shape close to spherical shape.

In said cascade, said magnetocaloric materials having different Curie temperatures are preferably separated from each other by a distance of 0.05 mm to 3 mm, more preferably 0.1 mm to 0.5 mm, thereby preventing cross contamination of the individual magnetocaloric materials by constituents of other magnetocaloric materials. The intermediate space between the different magnetocaloric materials is preferably filled by one or more thermally insulating materials to an extent of at least 90%, preferably completely.

The thermally insulating materials may be selected from any suitable materials. Preferred thermally insulating materials exhibit a low electrical conductivity as well as a low thermal conductivity, thereby preventing the occurrence of eddy currents and heat losses owing to thermal conduction from the hot side to the cold side. Preferably said thermally insulating materials combine high mechanical strength with good electrical and thermal insulating action. High mechanical strength of the thermally insulating materials allows reduction or absorption of the mechanical stresses in the magnetocaloric materials, which result from the cycle of introduction into and removal from the magnetic field. In the course of introduction into the magnetic field and removal from the magnetic field, the forces acting on the magnetocaloric materials may be considerable owing to the strong magnets.

Examples of suitable thermally insulating materials are engineering plastics, ceramics, inorganic oxides, glasses and combinations thereof.

Preferred magnetocaloric regenerators according to the present invention are those which exhibit two or more of the above-defined preferred features in combination.

In a third aspect, the present invention relates to the use of a kit according to the first aspect of the present invention for manufacturing a magnetocaloric regenerator according to the second aspect according to the present invention.

Regarding specific and preferred characteristics of said kits, reference is made to the disclosure provided above in the context of the first aspect of the present invention.

Preferably, said kit is one of the preferred kits described in the context of the first aspect of the present invention.

In a fourth aspect, the present invention relates to a device selected from the group consisting of refrigeration systems, climate control units, air conditioning devices, thermomagnetic power generators, heat exchangers, heat pumps, thermomagnetic actuators and thermomagnetic switches, wherein said device comprises a magnetocaloric regenerator according to the second aspect of the present invention.

Refrigeration systems, climate control units, air conditioning devices, heat exchangers, heat pumps, thermomagnetic actuators and thermomagnetic switches are generally known in the art.

A thermomagnetic power generator is a device which converts heat to electricity by means of the magnetocaloric effect. By heating and cooling a magnetocaloric material, the magnetization of the magnetocaloric material changes. The changing magnetization can be converted to electricity by exposing said changing magnetization to a coil, thereby inducting an electrical current in said coil.

Regarding specific and preferred characteristics of said magnetocaloric regenerators, reference is made to the disclosure provided above in the context of the second aspect of the present invention. Preferably, said magnetocaloric regenerator is one of the preferred magnetocaloric regenerators described in the context of the second aspect of the present invention.

In a fifth aspect, the present invention relates to the use of a magnetocaloric regenerator according to the second aspect of the present invention in a device selected from the group consisting of refrigeration systems, climate control units, air conditioning devices, thermomagnetic power generators, heat pumps, heat exchangers magnetic actuators and magnetic switches.

Regarding specific and preferred characteristics of said magnetocaloric regenerators, reference is made to the disclosure provided above in the context of the second aspect of the present invention. Preferably, said magnetocaloric regenerator is one of the preferred magnetocaloric regenerators described in the context of the second aspect of the present invention.

According to a sixth aspect of the present invention there is provided a process for preparing Z magnetocaloric materials of a composition according to formula (I)

(MnₓFe₁₋ₓ)₂₊ᵤP_{y}SiᵥC_{z}NᵣB_{w} (I)

wherein

0.3≤x≤0.7 preferably 0.35≤x≤0.65,

−0.12≤u≤0.10, preferably −0.05≤u≤0.05

0.3≤y≤0.75, preferably 0.4≤y≤0.7

0.25≤v≤0.7, preferably 0.3≤v≤0.6

0≤z≤0.15, preferably 0.003≤z≤0.12

0≤r≤0.1, preferably 0≤r≤0.07

0≤w≤0.1, preferably 0≤w≤0.08

(y+v+w)≤1.05, preferably ≤1.02, preferably ≤1

(y+v+w+r)≥0.95, preferably ≥0.98, preferably ≥1

wherein Z≥2

wherein u, x, y, v, z, w and r are identical for each of said Z magnetocaloric materials according to formula (I)

wherein the Curie temperature of each of said Z magnetocaloric materials according to formula (I) differs from the Curie temperature of each of the other Z-1 magnetocaloric materials according to formula (I) by at least 0.5 K, preferably by at least 2 K

wherein preparation of each of the Z magnetocaloric materials according to formula (I) comprises the steps of
(a) providing a mixture of precursors comprising atoms of the elements iron, manganese, phosphorus, silicon and optionally of one or more of the elements carbon, nitrogen and boron
(b) reacting the mixture provided in step (a) to obtain a solid reaction product,
(c) optionally shaping of the solid reaction product obtained in step (b) to obtain a shaped solid reaction product,
(d) optionally exposing the solid reaction product obtained in step (b) or the shaped solid reaction product obtained in step (c) to an atmosphere comprising one or more hydrocarbons to obtain a carburized product
(e) heat treatment of the solid reaction product obtained in step (b) or the shaped solid reaction product obtained in step (c) or the carburized product obtained in step (d) at a heat treatment temperature to obtain a heat treated product, wherein said heat treatment temperature in step (e) of the preparation of each of said Z magnetocaloric materials is different from the heat treatment temperature in step (e) of the preparation of each of the other Z-1 magnetocaloric materials
(f) cooling the heat treated product obtained in step (e) to obtain a cooled product, and
(g) optionally shaping of the cooled product obtained in step (f).

Thus, in a process according to the invention a number (Z) of at least two magnetocaloric materials having identical stoichiometry as defined by formula (I) is prepared, wherein the Curie temperature of each of said Z magnetocaloric materials according to formula (I) differs from the Curie temperature of each other of said Z magnetocaloric materials according to formula (I) by at least 0.5 K, preferably by at least 2 K. In said process, said heat treatment temperature in step (e) of the preparation of each of said Z magnetocaloric materials according to formula (I) is different from the heat treatment temperature in step (e) of the preparation of each other of said Z magnetocaloric materials according to formula (I). As used herein, identical stoichiometry as defined by formula (I) means that for each of said Z materials prepared by said process, the variables x, u, y, v, r, z and w have the same value. In other words, the Z magnetocaloric materials prepared by a process according to the present invention are defined by one and the same empirical formula falling in the scope of above-defined formula (I).

Surprisingly it has been found that by variation of the temperature of the heat treatment performed in step (e) the Curie temperature of a magnetocaloric material according to formula (I) may be adjusted very precisely. Thus, by applying in above-defined step (e) of the preparation of each of said Z magnetocaloric materials according to formula (I) a heat treatment temperature which is different from the heat treatment temperature in step (e) of the preparation of each of the other Z-1 magnetocaloric materials according to formula (I), Z magnetocaloric materials according to formula (I) having different Curie temperature at identical stoichiometry may be obtained. Without wishing to be bound by theory it is presently assumed that varying the heat treatment temperature in step (e) has an effect on the distribution of different phases which may be present in each of said Z magnetocaloric materials according to formula (I), and said distribution of phases in turn has an influence on the Curie temperature, and typically also on other parameters relevant for the technical application of magnetocaloric materials, like the thermal hysteresis and the entropy change.

Preferably, said heat treatment temperature in step (e) of the preparation of each of said Z magnetocaloric materials is in the range of from 1000° C. to 1200° C., preferably of from 1050° C. to 1150° C. The temperature range wherein a desirable variation of the Curie temperature or another magnetocaloric parameter may be obtained depends on the composition of the mixture of precursors and can be determined by the skilled person by means of preliminary tests.

Further preferably, said heat treatment temperature in step (e) of the preparation of each of said Z magnetocaloric materials differs from the heat treatment temperature in step (e) of the preparation of each of the other Z-1 magnetocaloric materials by 50 K or less, preferably by 25 K or less, further preferably by 10 K or less, still further preferably by 5 K or less and most preferably by 2 K or less.

Interestingly, it was found that that varying the duration of the heat treatment (for instance from one hour to 25 hours) in step (e) at a temperature within the above-defined range usually does not have a strong influence on both the thermal hysteresis and the Curie temperature. However, the ferro-to-paramagnetic transition becomes slightly sharper and the magnetic entropy change slightly increases as the duration of the heat treatment increases, due to increased compositional homogeneity of materials obtained after a longer heat treatment.

The mixture of precursors provided in step (a) comprises precursors comprising atoms of iron, manganese, phosphorus and silicon. Optionally, the mixture provided in step (a) further comprises precursors comprising atoms of one or more from the group consisting of carbon, boron and nitrogen. In the mixture of precursors to be provided in step (a) the stoichiometric ratio of the total amounts of atoms of the elements manganese, iron, silicon and phosphorus and optionally carbon, boron and nitrogen is adjusted so that in said mixture of precursors the stoichiometric ratio of the total amounts of atoms of said elements corresponds to formula (I).

In the mixture of precursors, manganese, iron, phosphorus, silicon, carbon (if present) and boron (if present) occur in elemental form and/or in the form of one or more compounds comprising one or more of said elements, preferably one or more compounds consisting of two or more of said elements. If nitrogen is present in the mixture of precursors, nitrogen is preferably present in the form of one or more compounds wherein nitrogen has a negative oxidation number.

In the process according to the present invention, atoms of carbon—if desired—may be provided in the form of precursors comprising atoms of carbon in the mixture provided in step (a), and/or in the form of hydrocarbons in step (d).

Elemental carbon may be selected from the group consisting of graphite and amorphous carbon. Carbon obtained from pyrolysis of carbonizable organic compounds is also a suitable precursor for providing carbon atoms. Carbonizable organic compounds are those which can be transferred into a product mainly consisting of carbon by pyrolysis (thermo-chemical cleavage of bonds under heat and non-oxidizing atmosphere, also referred to as charring or carbonization). If carbonizable organic compounds are provided in the mixture of precursors, they are pyrolyzed during step (b).

Preferably, in step (a), said mixture of precursors comprises one more substances selected from the group consisting of elemental manganese, elemental iron, elemental silicon, elemental phosphorus, phosphides of iron, phosphides of manganese, and optionally one or more of elemental carbon, carbides of iron, carbides of manganese, carbonizable organic compounds, elemental boron, nitrides of iron, borides of iron, borides of manganese, ammonia gas and nitrogen gas.

Step (a) is carried out by means of any suitable method. Preferably the precursors are powders, and/or the mixture of precursors is a powder mixture. If necessary, the mixture is ground in order to obtain a microcrystalline powder mixture. Mixing may comprise a period of ball milling which also provides suitable conditions for reacting the mixture of precursors in the solid state in subsequent step (b) (see below).

In step (b) the mixture provided in step (a) is reacted in the solid and/or liquid phase. Accordingly, step (b) comprises
(b-1) reacting the mixture provided in step (a) in the solid phase obtaining a solid reaction product
and/or
(b-2) transferring the mixture provided in step (a) or the solid reaction product obtained in step (b-1) into the liquid phase and reacting it in the liquid phase obtaining a liquid reaction product, and transferring the liquid reaction product into the solid phase obtaining a solid reaction product.

In certain processes according to the invention, reacting is carried out in the solid phase (b-1) over the whole duration of step (b) so that a solid reaction product is obtained. In other processes according to the invention, reacting is carried out exclusively in the liquid phase (b-2) so that a liquid reaction product is obtained which is transferred into the solid phase obtaining a solid reaction product. Alternatively, reacting according to step (b) comprises one or more periods wherein reacting is carried out in the solid phase and one or more periods wherein reacting is carried out in the liquid phase. In preferred cases the reacting in step (b) consists of a first period wherein reacting is carried out in the solid phase (b-1) followed by a second period wherein reacting is carried out in the liquid phase (b-2) obtaining a liquid reaction product which is transferred into the solid phase obtaining a solid reaction product. Preferably, step (b) is carried out under a protective gas atmosphere.

In a preferred process according to the present invention, in step (b-1) reacting of the mixture in the solid phase comprises ball-milling so that a solid reaction product in the form of a powder is obtained.

In another preferred process according to the present invention, in step (b-2) reacting of the mixture comprises reacting of the mixture in the liquid phase by melting together the mixture of precursors, e.g. in an induction oven, preferably under a protecting gas (e.g. argon) atmosphere and/or in a closed vessel. Step (b-2) also comprises transferring said liquid reaction product into the solid phase obtaining a solid reaction product. Transferring said liquid reaction product into the solid phase is carried out by means of any suitable method, e.g. by quenching, melt-spinning or atomization.

Quenching means cooling of the liquid reaction product obtained in step (b-2) in such manner that the temperature of said liquid reaction product decreases faster than it would decrease in contact with resting air.

The technique of melt-spinning is known in the art. In melt spinning the liquid reaction product obtained in step (b-2) is sprayed onto a cold rotating metal roll or drum. Typically the drum or roll is made of copper. Spraying is achieved by means of elevated pressure upstream of the spray nozzle or reduced pressure downstream of the spray nozzle.

Typically the rotating drum or roll is cooled. The drum or roll preferably rotates at a surface speed of 10 to 40 m/s, especially from 20 to 30 m/s. On the drum or roll, the liquid composition is cooled at a rate of preferably from 10² to 10⁷ K/s, more preferably at a rate of at least 10⁴ K/s, especially with a rate of from 0.5 to 2*10⁶ K/s. Preferably, melt spinning is carried out under a protecting gas (e.g. argon) atmosphere. Melt spinning enables a more homogeneous element distribution in the obtained reaction product which leads to an improved magnetocaloric effect.

Atomization corresponds to mechanical disintegration of the liquid reaction product obtained in step (b-2) into small droplets, e.g. by means of a water jet, an oil jet, a gas jet, centrifugal force or ultrasonic energy. The droplets solidify and are collected on a substrate.

In a preferred process according to the present invention, in step (b-2) transferring the obtained liquid reaction product into the solid phase is carried out by quenching, melt-spinning or atomization.

In step (b), any carbonizable organic compounds present in the mixture of precursors provided in step (a) are pyrolyzed, i.e. transferred into carbon.

Optional step (c) is carried out by means of any suitable method. For instance, when the reaction product obtained in step (b) is a powder, in step (c) said powder obtained in step (b) is shaped by pressing, molding, rolling, extrusion (especially hot extrusion), metal injection molding, tape casting or more recent powder-based technologies known from Additive Manufacturing like e.g. Binder Jetting, 3D Screen Printing or Selective Laser Melting.

Optional step (d) is performed in a manner similar to the commonly known gas carburization of iron alloys, especially of steel. The hydrocarbons used in step (d) are preferably selected from the group consisting of methane, propane and acetylene. Preferably, the atmosphere to which the solid reaction product obtained in step (b) or the shaped solid reaction product obtained in step (c) is exposed further comprises an inert gas, e.g. argon.

When the solid reaction product obtained in step (b) or the shaped solid reaction product obtained in step (c) is in the form of particles having a size of 100 μm or less, or even 10 μm or less, step (d) allows to obtain a product (carburized product) having a relatively homogeneous loading of carbon, since under usual carburization conditions the depth of diffusion of carbon is in the range of several millimeters.

Carburized iron alloys are mechanically stronger and more corrosion resistant, compared to their non-carburized precursors. It is believed that for magnetocaloric materials step (d) has a similar advantageous effect.

Step (e) is carried out by means of any suitable method. In step (e) the maximum temperature to which the solid reaction product obtained in step (b) or the shaped solid reaction product obtained in step (c) or the carburized product obtained in step (d) is exposed is below its melting temperature. Step (e) is performed in order to cure structural defects and to thermodynamically stabilize the reaction product obtained in step (b) or the carburized product obtained in step (d), and/or to strengthen and compact the shaped solid reaction product obtained in step (c) by fusing together the material grains.

Preferably, in step (e) the heat treatment comprises sintering the solid reaction product obtained in step (b) or the shaped solid reaction product obtained in step (c) or the carburized product obtained in step (d), preferably under a protective gas atmosphere.

In particularly preferred processes according to the present invention, wherein step (b) involves melt-spinning, a heat treatment having a duration of 5 hours or less may be sufficient, because melt spinning provides for a rather homogeneous element distribution in the obtained reaction product.

In a preferred mode of carrying out step (e), during a stage of sintering the material grains are fused together so that the cohesion between the material grains of the shaped solid reaction product is increased and the porosity is reduced, and during a stage of annealing, the crystal structure is homogenized and crystal defects are cured.

Within step (e), cooling down of the sintered and optionally annealed product may be carried out by turning off the furnace (known to the specialist as “furnace cooling”).

Step (f) is carried out by means of any suitable method. In a preferred process according to the present invention, step (f) includes contacting the heat treated product obtained in step (e) with a liquid or gaseous medium, preferably at a quenching rate of 200 K/s or less, preferably ≤100 K/s or less, most preferably ≤25 K/s.

Particularly preferably, quenching is carried out by means of contacting the heat treated product obtained in step (e) with oil, water or aqueous liquids, for example cooled water or ice/water mixtures. Oils for quenching are available in the market. For example, the heat treated product obtained in step (e) is allowed to fall into ice-cooled water. It is also possible to quench the heat treated product obtained in step (e) with sub-cooled gases such as liquid nitrogen or liquid argon.

Step (g) is carried out by means of any suitable method. For instance, when the cooled product obtained in step (f) is in a shape not suitable for the desired technical application (e.g. in the form of a powder), in step (g) said cooled product obtained in step (f) is transferred into a shaped body by means of pressing, molding, rolling, extrusion (especially hot extrusion) or metal injection molding. Alternatively, the cooled product obtained in step (f) which is in the form of a powder or has been transferred into the form of a powder is mixed with a binding agent, and said mixture is transferred into a shaped body in step (g). Suitable binding agents are oligomeric and polymeric binding systems, but it is also possible to use low molecular weight organic compounds, for example sugars. The shaping of the mixture is achieved preferably by casting, injection molding or by extrusion. The binding agent either remains in the shaped body or is removed catalytically or thermally so that a porous body with monolith structure or a mesh structure is formed.

Preferred processes according to the present invention are those which exhibit two or more of the above-defined preferred features in combination.

### EXAMPLES

Magnetocaloric Materials According to Formula (Ia)

Stoichiometric amounts according to the formulae indicated below of manganese chips were mixed with Fe₂P powder and electronic grade Si chips and the obtained precursor mixture was brought into a graphite crucible. The crucible was brought into a gas atomization equipment (Phoenix Scientific Instruments, HERMIGA 75) inertised with Argon gas. The crucible content was heated by induction, molten and brought up to a temperature of 1500° C. The stopper rod was released and a jet of molten material emerged from the crucible and was fragmented by directing a jet of Argon gas onto it. The resulting droplets fell down in the atomizing tower, solidified and were collected. A size range of 100-150 μm particle size was generated from the atomized powder by classification.

The Curie temperature Tc and the thermal hysteresis ΔT_{hys} are determined from differential scanning calorimetry (DSC) zero field measurements. Thermal hysteresis is the difference between the position of Tc in cooling vs. heating mode.

The parameter ΔS_{1.5T} (magnetic entropy change at a magnetic field change of 1.5 T) is determined by means of in-field differential scanning calorimetry. This method enables the measurement of the specific heat as a function of both temperature and external magnetic field. The external magnetic field is generated by a permanent magnet.

The weight fractions of phases (i), (ii) and (iii) can be determined by Rietveld refinement of X-ray diffraction data.

### Example 1: Mn_{1.20}Fe_{0.75}P_{0.49}Si_{0.51}

6 samples of 20 g of a powder of the stoichiometry Mn_{1.20}Fe_{0.75}P_{0.49}Si_{0.51} with a particle size in the range of from 100 to 150 μm were heat treated in evacuated and sealed quartz ampoules. The ampoules were heat treated for 24 h each at a different temperature Tₕₜ as indicated in table 1 and subsequently quenched in water. Properties of the obtained magnetocaloric materials are listed in table 1.

TABLE 1
Properties of Mn_{1.20}Fe_{0.75}P_{0.49}Si_{0.51}
after heat treatment at different temperatures

| Tₕₜ | T_{c} | ΔS_{1.5 T} | Hysteresis | Phase (i) | Phase (ii) | Phase (iii) |
|---|---|---|---|---|---|---|
| [° C.] | [K] | [J/kg · K] | [K] | [wt.-%] | [wt.-%] | [wt.-%] |
| 1150 | 241 | 17.8 | 8.9 | 84 | 8 | 8 |
| 1125 | 269 | 16.9 | 5.5 | 87 | 7 | 6 |
| 1100 | 290 | 14.6 | 3.2 | 92 | 4 | 4 |
| 1075 | 306 | 13.2 | 1.8 | 96 | 2 | 2 |
| 1050 | 318 | 9.8 | 1.1 | 99 | 1 | — |
| 1025 | 316 | 8.5 | 0.7 | 97 | 3 | — |

Table 1 shows an increase of the thermal hysteresis with increasing heat treatment temperature in the range of from 1050° C. to 1150° C., but nevertheless the magnetocaloric effect of all materials is suitable for practical applications. The optimum value for ΔS_{1.5T} is obtained at a content of phase (i) of 84 wt.-%; while the optimum value for the thermal hysteresis ΔT_{hys} is found at higher contents of phase (i), namely 97-99 wt.-%. Thus, materials having acceptable magnetocaloric properties are obtained by performing a heat treatment at temperatures in the range of from 1025° C. to 1150° C. Accordingly, example 1 provides a kit comprising six technically useful magnetocaloric materials each having the same stoichiometry Mn_{1.20}Fe_{0.75}P_{0.49}Si_{0.51} with Curie temperatures covering a range of from about 240 K to 320 K, wherein the Curie temperature of each of said six magnetocaloric materials differs from the Curie temperature of each other the five other magnetocaloric materials by at least 0.5 K.

### Example 2: Mn_{1.19}Fe_{0.77}P_{0.47}Si_{0.53}

5 samples of 20 g of powder of the stoichiometry Mn_{1.19}Fe_{0.77}P_{0.47}Si_{0.53} with a particle size of from 100 to 150 μm were heat treated in evacuated and sealed quartz ampoules. The ampoules were heat treated for 24 h each at a different temperature Tₕₜ as indicated in table 2 and subsequently quenched in water. Properties of the obtained magnetocaloric materials are listed in table 2.

TABLE 2
Properties of Mn_{1.19}Fe_{0.77}P_{0.47}Si_{0.53}
after heat treatment at different temperatures

| Tₕₜ | T_{c} | ΔS_{1.5 T} | Hysteresis | Phase (i) | Phase (ii) | Phase (iii) |
|---|---|---|---|---|---|---|
| [° C.] | [K] | [J/kg*K] | [K] | [wt.-%] | [wt.-%] | [wt.-%] |
| 1150 | 237 | 14.0 | 7.4 | 80 | 8 | 12 |
| 1125 | 261 | 13.8 | 4.9 | 83 | 7 | 10 |
| 1100 | 286 | 11.2 | 2.3 | 86 | 6 | 8 |
| 1075 | 304 | 10.3 | 1.2 | 91 | 3 | 6 |
| 1025 | 320 | 5.2 | 7.6 | 92 | 2 | 6 |

Table 2 shows an increase of the thermal hysteresis with increasing heat treatment temperature in the range of from 1075° C. to 1150° C. The optimum value for is ΔS_{1.5T} obtained at a content of phase (i) of 80 wt.-%; while the optimum value for the thermal hysteresis ΔT_{hys} is found at a higher content of phase (i), namely 91 wt.-%. Thus, materials having acceptable magnetocaloric properties are obtained by performing a heat treatment at temperatures in the range of from 1025° C. to 1150° C. Accordingly, example 2 provides a kit comprising five technically useful magnetocaloric materials each having the same stoichiometry Mn_{1.19}Fe_{0.77}P_{0.47}Si_{0.53} with Curie temperatures covering a range of from about 240 K to 320 K, wherein the Curie temperature of each of said five magnetocaloric materials differs from the Curie temperature of each of the two other magnetocaloric materials by at least 0.5 K.

Magnetocaloric Materials According to Formula (Ib)

According to formula MnFe_{0.95}P_{0.595}Si_{0.33}B_{0.075}, stoichiometric amounts of Mn, Fe, B, red P and Si (each in powder form) were mixed, and the obtained mixture was ball milled for 10 hours with a constant rotation speed of 380 rpm in an argon atmosphere. The obtained solid reaction product was pressed using a pressure of 150 kgfcm⁻² into small tablets. Each tablet was sealed in quartz ampoules under 200 mbar of Ar before being subjected to a heat treatment in a furnace.

A first group of samples HT1-HT4 (each in the form of a tablet sealed in an ampoule) was subject to a heat treatment at a temperature of 1373 K (1100° C.) for different durations, namely 1 hour, 7 hours, 20 hours and 25 hours. A further sample HT5 was subject to heat treatment comprising two heat treatment steps at different temperatures, namely sintering at 1373 K for 2 h and annealing at 1123 K for 20 h. Then the sample was slowly cooled to room temperature before it was re-sintered at 1373 K for 20 h to achieve a homogeneous composition.

Samples H1-H5 served for comparison purposes.

A second group of samples HT6-HT9 (each in the form of a tablet sealed in an ampoule) was subject to heat treatment each at different temperatures, namely 1273 K (1000° C.), 1323 K (1050° C.), 1373 K (1100° C.) and 1423 K (1150° C.), in each case for a duration of 2 hours.

For the heat treatment of all samples HT1-HT9, the temperature of the furnace was set to the desired temperature of the heat treatment before transferring the quartz ampoule into the furnace. This approach is expected to eliminate the formation of the phase (Mn,Fe)₃Si, which may be formed at lower temperatures. At the end of the heat treatment, each sample was quenched into water.

Before performing any measurements, all samples were put into liquid nitrogen for 10-15 minutes to completely remove the virgin effect, which is intrinsic to (Mn,Fe)₂(P,Si)-based materials.

The crystal structure of all the samples was investigated by X-ray diffraction (XRD) using a PANalytical X-pert Pro diffractometer with Cu—K, radiation. The XRD measurements for the structural analysis were performed at 150 K, a temperature at which all the samples are in the ferromagnetic state. The XRD data of all the samples are refined using the Fullprof program.

Measurements of the temperature dependence of the magnetization were carried out in a commercial superconducting quantum interference device (SQUID) magnetometer (Quantum Design MPMS 5XL) in the reciprocating sample option (RSO) mode. The isothermal magnetic entropy change of all the samples is derived from the isofield magnetization M_{B}(T) data using the Maxwell relation

$$Δ {S}_{m} ( T , B ) = {\sum }_{i} \frac{{M}_{i + 1} ( {T}_{i + 1} , B ) - {M}_{i} ( {T}_{i} , B )}{{T}_{i + 1} - {T}_{i}} Δ B$$

### Example 3: Effect of Duration of Heat Treatment (Comparison Example)

The XRD patterns (not shown) of the samples HT1-HT5 subjected to heat treatment at 1373 K for different durations (see table 3) indicate that all samples exhibit a main phase having the hexagonal Fe₂P-type structure (space group P-62m) even when the sample was annealed for only 1 h. No additional reflections are observed for increasing annealing times, indicating that the formation of the Fe₂P-type main phase is not affected by the duration of the heat treatment. The longer heat treatment appears to enhance the compositional homogeneity. The lattice parameters c and a and the c/a ratio obtained by the Rietveld refinement method are summarized in Table 3. The results indicate that there are very small changes in the lattice parameters for increasing annealing times, leading to a very small reduction in the c/a ratio.

TABLE 3
The crystal lattice constants a and c, the c/a ratio, the isothermal magnetic
entropy change ΔSₘ, Curie temperature T_{C} and thermal hysteresis ΔT_{hys} of
MnFe_{0.95}P_{0.595}Si_{0.33}B_{0.075} after heat treatment of different duration

| Sample number | | | | ΔSₘ | | | |
|---|---|---|---|---|---|---|---|
| and duration of | a | c | | (Jkg⁻¹K⁻¹) | | T_{C} | ΔT_{hys} |
| heat treatment | (Å) | (Å) | c/a | 1 T | 2 T | (K) | (K) |
| HT1 (1 h) | 6.1175 | 3.2960 | 0.5387 | 4.2 | 6.7 | 293 | <1 |
| HT2 (7 h) | 6.1188 | 3.2957 | 0.5386 | 5.1 | 8.0 | 292 | 1.3 |
| HT3 (20 h) | 6.1193 | 3.2947 | 0.5384 | 6.5 | 9.6 | 291 | <1 |
| HT4 (25 h) | 6.1207 | 3.2947 | 0.5383 | 6.5 | 9.3 | 294 | <1 |
| HT5 | 6.1207 | 3.2946 | 0.5383 | 7.6 | 10.3 | 294 | <1 |
| (two-step heat | | | | | | | |
| treatment as | | | | | | | |
| defined above) | | | | | | | |

In FIG. 1 the magnetization as a function of temperature during heating and cooling at a rate of 2 K/min under a field of 1 T is shown for the samples listed in table 3. It is obvious that varying the duration of the heat treatment does not have a strong influence on both the thermal hysteresis and the Curie temperature. Moreover, the Curie temperature of sample HT5 which was subject to a two-step heat treatment as defined above is almost the same as that of all the samples HT1-HT4 annealed at 1373 K for different times. The ferro-to-paramagnetic (FM-PM) transition becomes slightly sharper as the annealing time increases, which can be attributed to enhanced compositional homogeneity obtained by the longer heat treatment.

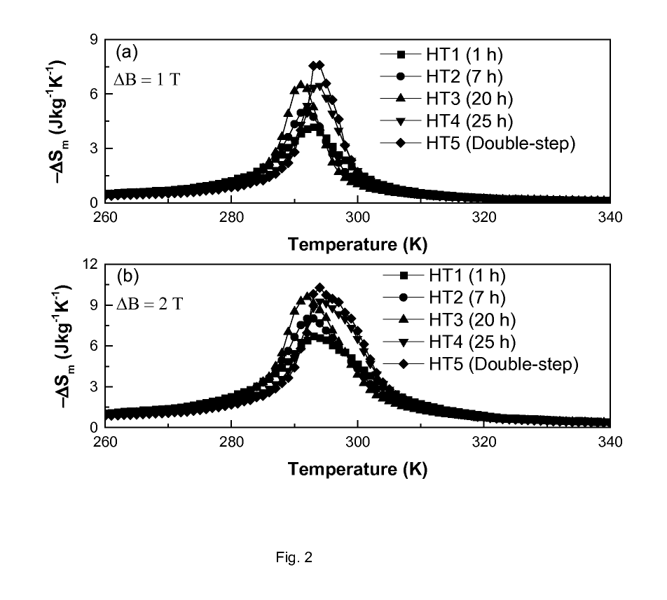

In FIG. 2 the temperature dependence of the magnetic entropy change under a magnetic field change of 1 T (FIG. 2a) and 2 T (FIG. 2b) is shown for the samples listed in table 3. As the duration of heat treatment increases the magnetic entropy change (ΔSₘ) at first increases gradually and then saturates after 20 h of heat treatment. The higher values of ΔSₘ for increasing duration of heat treatment appear to be due to an increase in the sharpness of the FM-PM transition, which in turn is due the enhanced compositional homogeneity obtained by the longer heat treatment, see above.

### Example 4: Effect of Temperature of Heat Treatment

The XRD patterns (not shown) of the samples HT6-HT9 subjected to heat treatment at different temperatures for different durations (see table 4) indicate that all samples exhibit a main phase having the hexagonal Fe₂P-type structure (space group P-62m). As the temperature of the heat treatment increases the diffraction peaks become narrower and exhibit a higher intensity, suggesting an increase in the particle size. Moreover, an extra reflection at 2θ≈22.1° was observed for the sample heat treated at 1423 K, indicating the formation of a new phase at this annealing temperature.

TABLE 4
The crystal lattice constants a and c, the c/a ratio, isothermal magnetic
entropy change ΔSₘ, Curie temperature T_{C} and thermal hysteresis ΔT_{hys} of
MnFe_{0.95}P_{0.595}Si_{0.33}B_{0.075} after heat treatment of different temperature

| Sample number | | | | ΔSₘ | | | |
|---|---|---|---|---|---|---|---|
| and temperature | a | c | | (Jkg⁻¹K⁻¹) | | T_{C} | ΔT_{hys} |
| of heat treatment | (Å) | (Å) | c/a | 1 T | 2 T | (K) | (K) |
| HT6 (1273 K) | 6.1070 | 3.3121 | 0.5424 | 2.7 | 5.0 | 262 | 5.4 |
| HT7 (1323 K) | 6.1227 | 3.2987 | 0.5388 | 6.2 | 10.0 | 285 | <1 |
| HT8 (1373 K) | 6.1207 | 3.2947 | 0.5383 | 6.5 | 9.3 | 294 | 1.1 |
| HT9 (1423 K) | 6.1210 | 3.2991 | 0.5390 | 9.1 | 12.7 | 278 | 2.6 |

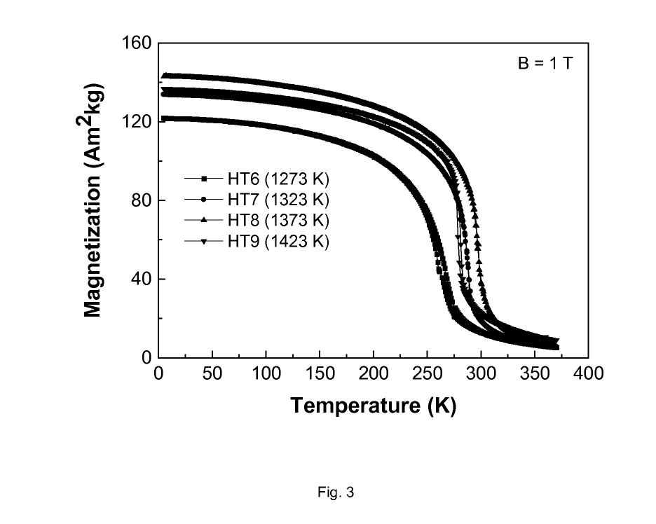

In FIG. 3 the magnetization as a function of temperature during heating and cooling at a rate of 2 K/min under a field of 1 T is shown for the samples listed in table 4. The results indicate that the Curie temperature is quite sensitive to the temperature of the heat treatment. In the temperature range from 1273 to 1373 K, the Curie temperature linearly increases with the increasing temperature of the heat treatment. However, the Curie temperature decreases from 294 to 278 K as the temperature of the heat treatment increases from 1373 K to 1423 K. This may be attributed to the formation of a new phase when annealing at higher temperatures, resulting in a slight change in the composition of the main phase. The change in Tc as a function of the temperature of the heat treatment is consistent with the change in c/a ratio (see table 4). The experimental results also show that the samples subjected to heat treatment at higher temperatures present relatively sharper FM-PM transitions. The sharper transition, relative higher saturation magnetization and smaller hysteresis with increasing temperature of the heat treatment can be attributed to enhanced compositional homogeneity and larger crystal size of the samples subject to heat treatment at higher temperature.

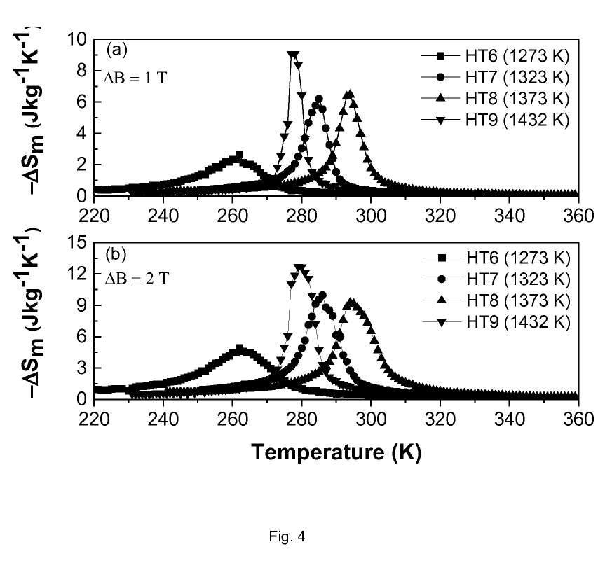

In FIG. 4 the temperature dependence of the magnetic entropy change under a magnetic field change of 1 T (fig. a) and 2 T (FIG. 4b) is shown for the samples listed in table 4. For the external magnetic field changes of both 1 and 2 T, the isothermal magnetic entropy change (ΔSₘ) increases significantly as the temperature of the heat treatment increases from 1273 to 1323 K and then hardly changes on increasing the temperature of the heat treatment to 1373 K. However, a further increase in temperature of the heat treatment to 1423 K leads to a significant increase in the magnetic entropy change, suggesting that the presence of the additional phase (as observed in the XRD pattern, see above) does not have a negative effect on the magnetocaloric properties. Increasing the temperature of the heat treatment appears to enhance the compositional homogeneity, which leads to a sharper first-order magnetic phase transition.

1 A kit, comprising:
A magnetocaloric materials,
wherein each of the Z magnetocaloric materials is a composition of formula (I):
(MnₓFe₁₋ₓ)₂₊ᵤP_{y}SiᵥC_{z}NᵣB_{w} (I),
wherein
0.3≤x≤0.7;
−0.12≤u≤0.10;
0.3≤y≤0.75;
0.25≤v≤0.7;
0≤z≤0.15;
0≤r≤0.1;
0≤w≤0.1;
(y+v+w)≤1.05;
(y+v+w+r)≥0.95;
wherein u, x, y, v, z, r and w are identical for each of the Z magnetocaloric materials,
wherein Z≥2, and
wherein a Curie temperature of each of the Z magnetocaloric materials differs from a Curie temperature of each of other Z-1 magnetocaloric materials by at least 0.5 K.

2: The kit according to claim 1,
wherein each of the Z magnetocaloric materials comprises:
(i) a phase having a hexagonal structure of composition M₂X with a crystal lattice having space group P-62m in a weight fraction of from 80% to 100%,
(ii) a phase having a cubic structure of composition M₃X with a crystal lattice having space group Fm-3m in a weight fraction of from 0% to 20%, and
(iii) a phase having a hexagonal structure of composition M₅X₃ with a crystal lattice having space group P6₃/mcm in a weight fraction of from 0% to 20%,
wherein in each case,
M denotes atoms of elements selected from the group consisting of Fe and Mn and
X denotes atoms of elements selected from the group consisting of P, Si, C, N and B,
wherein for each of the Z magnetocaloric materials, sum of weight fractions of phases (i), (ii) and (iii) is 100%, and
wherein each of the Z magnetocaloric materials differs from each of the other Z-1 magnetocaloric materials by the weight fractions of at least two of the phases (i), (ii) and (iii).

3: The kit according to claim 1, wherein the Z magnetocaloric materials have Curie temperatures of from 220 K to 330 K.

4: The kit according to claim 1, wherein Z is from 3 to 100.

5: A magnetocaloric regenerator comprising:
Z magnetocaloric materials,
wherein each of the Z magnetocaloric materials is a composition of formula (I):
(MnₓFe₁₋ₓ)₂₊ᵤP_{y}SiᵥC_{z}NᵣB_{w} (I),
wherein
0.3≤x≤0.7;
−0.12≤u≤0.10;
0.3≤y≤0.75;
0.25≤v≤0.7;
0≤z≤0.15;
0≤r≤0.1;
0≤w≤0.1;
(y+v+w)≤1.05;
(y+v+w+r)≥0.95;
wherein u, x, y, v, z, r and w are identical for each of the Z magnetocaloric materials,
wherein Z≥2, and
wherein a Curie temperature of each of the Z magnetocaloric materials differs from a Curie temperature of each of other Z-1 magnetocaloric materials by at least 0.5 K.

6: The magnetocaloric regenerator according to claim 5, wherein the magnetocaloric regenerator comprises a cascade comprising the Z magnetocaloric materials, wherein Z≥3, and
wherein in the cascade, the magnetocaloric materials are arranged in succession by ascending or descending Curie temperature.

7: The magnetocaloric regenerator according to claim 5, wherein Z is from 3 to 100.

8: The magnetocaloric regenerator according to claim 6, wherein in the cascade, a temperature difference between two succeeding magnetocaloric materials is in each case from 0.5 K to 6K.

9: A method, comprising:
manufacturing a magnetocaloric regenerator with the kit of claim 1.

10: A device, comprising the magnetocaloric regenerator according to claim 5,
wherein the device is selected from the group consisting of a refrigeration system, a climate control unit, an air conditioning device, a thermomagnetic power generator, a heat exchanger, a heat pump, a thermomagnetic actuator, and a thermomagnetic switch.

11: A process for preparing Z magnetocaloric materials, wherein Z≥2, the process comprising:
(a) providing a mixture of precursors comprising atoms of elements iron, manganese, phosphorus, silicon and optionally one or more of elements carbon, nitrogen and boron;
(b) reacting the mixture to obtain a solid reaction product;
(c) optionally shaping of the solid reaction product to obtain a shaped solid reaction product;
(d) optionally exposing the solid reaction product or the shaped solid reaction product to an atmosphere comprising one or more hydrocarbons to obtain a carburized product;
(e) heat treatment of the solid reaction product or the shaped solid reaction product or the carburized product at a heat treatment temperature to obtain a heat treated product, wherein the heat treatment temperature in (e) in preparing each of the Z magnetocaloric materials is different from the heat treatment temperature in (e) in preparing each of other Z-1 magnetocaloric materials;
(f) cooling the heat treated product to obtain a cooled product; and
(g) optionally shaping of the cooled product,
wherein each of the Z magnetocaloric materials is a composition of formula (I):
(MnₓFe₁₋ₓ)₂₊ᵤP_{y}SiᵥC_{z}NᵣB_{w} (I),
wherein
0.3≤x≤0.7;
−0.12≤u≤0.10;
0.3≤y≤0.75;
0.25≤v≤0.7;
0≤z≤0.15;
0≤r≤0.1;
0≤w≤0.1;
(y+v+w)≤1.05;
(y+v+w+r)≥0.95;
wherein u, x, y, v, z, r and w are identical for each of the Z magnetocaloric materials, and
wherein a Curie temperature of each of the Z magnetocaloric materials differs from a Curie temperature of each of other Z-1 magnetocaloric materials by at least 0.5 K.

12: The process according to claim 11, wherein the mixture of precursors comprises one or more substances selected from the group consisting of elemental manganese, elemental iron, elemental silicon, elemental phosphorus, a phosphide of iron, a phosphide of manganese, and optionally one or more of elemental carbon, a carbide of iron, a carbide of manganese, a carbonizable organic compound, elemental boron, a nitride of iron, a boride of iron, a boride of manganese, ammonia gas and nitrogen gas.

13: The process according to claim 11, wherein the heat treatment temperature in (e) in preparing each of the Z magnetocaloric materials is from 1000° C. to 1200° C.

14: The process according to claim 11, wherein the heat treatment temperature in (e) in preparing each of the Z magnetocaloric materials differs from the heat treatment temperature in (e) in preparing each of the other Z-1 magnetocaloric materials by 50 K or less.

15: The process according to claim 16, wherein the process comprising reacting (b-2), and
in (b-2), transferring the liquid reaction product into the solid phase is carried out by quenching, melt-spinning or atomization.

16: The process according to claim 11, wherein the reacting (b) comprises:
(b-1) reacting the mixture in a solid phase to obtain the solid reaction product; and/or
(b-2) transferring the mixture or the solid reaction product into a liquid phase and reacting it in the liquid phase to obtain a liquid reaction product, and transferring the liquid reaction product into a solid phase to obtain the solid reaction product.
